(19) United States
(12) Patent Application Publication
(10) Pub. No.: US 2026/0352148 A1
(43) Pub. Date: Nov. 5, 2026

(54) HOLDING ARRANGEMENT FOR A SOLAR MODULE AND INSTALLATION METHOD

(71) Applicant: SFS Group International AG, Heerbrugg (CH)

(72) Inventors: Kun-Hao HUANG, Thal (CH); Hanspeter KUSTER, Balgach (CH); Stefan BRUNNSCHWEILER, Diepoldsau (CH); Nadja MUGHAL, Royersford, PA (US)

(73) Assignee: SFS Group International AG, Heerbrugg (CH)

(21) Appl. No.: 19/666,678

(22) Filed: May 4, 2026

(30) Foreign Application Priority Data
May 2, 2025 (EP) 25174081.7

(51) Int. Cl. H02S 30/00

(52) U.S. Cl. CPC H02S 30/00

(57) ABSTRACT

A mounting device (100) for the fall-proof mounting of solar modules, preferably on existing façade surfaces, includes the following elements: a longitudinally extended base rail having a base (240) and two legs (241, 242) projecting therefrom, having longitudinally arranged grooves (211, 212) facing one another; a module carrier (300) having a support plate (310) and a bracket (350) projecting perpendicularly therefrom, which can be engaged with the base rail (200); a retaining clip (400) having a through-opening (410) which, when mounted, surrounds the bracket (350) in a collar-like manner and can be firmly connected to the base rail (200) by a retaining screw (490); and a module clamp (500) or end clamp that can be screwed to the module carrier using a clamping screw (590), thereby securing a solar module in the mounting device. A method of installation for this mounting device is also provided.

### CROSS-REFERENCE TO RELATED APPLICATIONS

This application claims priority from European Patent Application No. 25174081.7, filed May 2, 2025, which is incorporated herein by reference as if fully set forth.

### TECHNICAL FIELD

The present invention relates to a mounting device for a solar module, photovoltaic module, PV module, or PV panel, specifically on façades or building envelopes. It further describes a method for the vertical installation of one or more such mounting devices.

### BACKGROUND

Solar modules for energy generation have become a functional and design element in industrial and private buildings that is often required by law. Since ground-mounted and rooftop installations have been common for decades, the focus is now shifting to façades. These offer several advantages that rooftop installations do not have, either in whole or in part. For example, in winter at high latitudes where the sun is low in the sky, solar systems mounted vertically on façades can be more efficient than those on roofs optimized for summer sun angles. Snow and dirt accumulation is also less pronounced. Furthermore, façades that are strongly oriented toward the west or east can be utilized to generate electricity during the early morning and late afternoon hours. Furthermore, particularly tall buildings have significantly larger façade areas compared to roof areas.

In this description, the building envelope is understood to be the totality of all components that enclose a building from the outside - simply put, the roof and façade. When examining the cross-section of a typical building envelope in industrial buildings from the inside out, an insulation layer is usually placed on a structurally load-bearing component, and, separated by a ventilation gap, a façade made of panels, trapezoidal sheets, or similar materials is mounted in front of it. This façade itself is mechanically fastened to a substructure, which is usually constructed of metal and connected directly to the structurally load-bearing wall through the insulation layer.

Such a curtain wall, as the outer finish of the building envelope, thus covers the substructure or building insulation and protects it from environmental influences. If an existing building surface is to serve as the basis for a photovoltaic system, the solar modules are usually mounted on the façade - if only for cost reasons.

### DESCRIPTION OF THE PRIOR ART

In roof installations, clamping mounting devices are frequently used, in which solar modules are placed on point or strip-shaped supports made of aluminum profiles and secured using screws and clamps. To use these systems on vertical surfaces, additional anchoring components are then required to support the solar modules’ dead weight. These additions increase the complexity of the installation.

The prior art WO 2021/108492 A1 discloses a twist-lock clamp for securing a solar module to a U-shaped mounting rail. Such a twist-lock clamp comprises a flange nut, a screw, a spring element, and a clamping jaw. The screw passes through the clamping jaw and the spring element and is screwed into the thread of the flange nut. After inserting the flange nut into two guides of the rail, the frame of a solar module can be clamped between the clamping jaw and the rail.

EP 2 662 645 A2 is based on a similar principle; here, the flange nut is designed as a slotted nut that can also be screwed to a clamping jaw, but does not require a spring element. Clamping also occurs between a base rail and the aforementioned clamping jaw.

### SUMMARY

Based on this prior art, it is the object of the present invention to provide a simple yet reliable method for fastening solar modules to an existing façade.

Furthermore, the fastening system should consist of as few individual parts as possible to minimize the effort required for inventory management and installation.

In the present case, a mounting device for solar modules is described that is particularly, but not exclusively, suitable for installation on existing industrial façades.

### DEFINITIONS

In this description, a photovoltaic panel, PV panel, PV module, or solar module is understood to be an arrangement of a large number of interconnected solar cells, which are typically arranged behind a protective glass plate and enclosed by a structural frame. Such frames are generally made of aluminum profiles. Since solar modules are used on roofs, façades, or in ground-mounted installations, a frame offers the greatest flexibility as a mechanical interface for mounting. Solar modules can be fastened mechanically by directly screwing them to suitable substructures or, alternatively, using mounting devices that very often rely on clamping elements or insert systems for fastening.

In this document, “mounting elements” refers to the mechanical components that establish a connection between a solar module and a substructure or existing façade. A mounting device is thus a set of mounting elements that, when combined, enable the proper installation of a solar module.

The term BAPV stands for "building-attached photovoltaics," as opposed to BIPV, which stands for "building-integrated photovoltaics." BIPV means that solar modules are integrated into the building envelope, i.e., installed as part of the roof and/or façade. In BAPV, the solar modules are mounted on an existing, new, or renovated roof or a corresponding façade. The present invention is particularly suitable as BAPV on vertical façades. However, this does not preclude use on flat roofs or other sloped surfaces. Nor is use as BIPV fundamentally ruled out.

### DESCRIPTION OF THE INVENTION

The mounting device described in this document is intended to secure solar modules to or on a building envelope. The components are designed for this purpose but do not preclude use on a pure substructure (i.e., a supporting structure designed solely for structural purposes). The mounting device comprises several components for this purpose:

Base rail: The base rail is a long (elongated) profile element with a U-shaped cross-section in its basic form, or a profile element having a U-shaped section. The base rail can be mounted vertically on an existing façade or is designed for mounting on such a façade. The base rail comprises a base and two lateral legs, i.e., side flanges projecting from this base. At the (open) end of these legs are two longitudinally arranged grooves that face each other, with their openings oriented toward one another, thus forming a gap between them.

Module carrier: This comprises a support plate and a bracket arranged at right angles to it. The end face of this bracket thus lies parallel to the plane of the support plate. The support plate can engage with the grooves of the base rail, thereby filling the gap and becoming movable there only in the longitudinal direction of the base rail. The bracket serves as a support for a solar module during installation, bearing the dead weight of the solar module and transferring it via the support plate to the base rail.

Retaining clip: This clip is the component used to secure the position of the module carrier within or on the base rail. The retaining clip has an opening that, when installed, encloses the bracket at the transition to the support plate like a flat collar. At the same time, it grips the base rail like a clamp and can optionally be secured there with a retaining screw.

Module clamp or end clamp: Both the module clamp and the end clamp are components used to secure a solar module to an assembled arrangement consisting of a base rail, module carrier, and retaining clip. Both the module clamp and the end clamp clamp the module between a (clamping) jaw and the retaining clip. The clamps can be secured to the module carrier, specifically to the bracket, using a clamping screw. A module clamp has two spatially separated clamping surfaces, which, together with corresponding surfaces of the retaining clip, form a pair of clamping jaws capable of securely holding a single solar module. An end clamp, on the other hand, has only a single clamping surface, which forms a pair of clamping jaws with one of the clamping surfaces of the retaining clip. Both types of clamps thus secure a solar module in its position on the façade and prevent it from falling out of the mounting device, but do not primarily transfer the dead weight of the solar module to the base rail.

In a preferred embodiment, the outer surfaces of the lateral legs of the base rail are partially (i.e., at least in certain areas) aligned parallel to one another. Alternatively, the outer surfaces, legs, or side surfaces could also be designed to be slightly inclined relative to one another. As described below, the outer surfaces serve as contact surfaces for parts of the retaining clip.

The retaining clip has a U-shaped cross-sectional structure with a clip base and two parallel side flanges projecting therefrom, wherein the outer side of the clip base comprises the clamping surfaces against which the solar modules will later rest. In a particularly suitable form, also shown in the drawings, the side flanges are arranged at the longitudinal ends of the retaining clip. The internal dimensions of the U-shape are selected such that the retaining clip can be slipped over the base rail with a positive fit. In the basic design, the retaining clip enables only a form-fit on the base rail; however, by incorporating spring tabs, an additional force-fit or clamping fit can be achieved. Complete fixation and fall protection are achieved by using a retaining screw.

As mentioned, the retaining clip features a through-opening. This is dimensioned so that it can be slipped over the module carrier, more precisely its bracket, for installation. This is done by guiding the bracket, with its front side leading, through the through-opening with minimal clearance, so that the retaining clip surrounds the bracket like a collar once the retaining clip has reached its final position.

As mentioned above, the solar modules are clamped between the clamping surfaces of the module clamp and the contact surfaces or clamping surfaces of the retaining clip. Clamping thus never occurs directly between the base rail and the module clamp, but rather via the intermediate retaining clip. This has the advantage that - in contrast to the open top end of the base rail - the frame of a solar module does not rest on the linear edges of the base rail, but rather rests flat against the clamping surfaces of the clip base of the retaining clip.

Thus, the through-opening - or, when mounted, the bracket - separates the two clamping surfaces. When the mounting device is mounted vertically, they are therefore located above and below the bracket.

As mentioned above, in the pre-mounted or mounted state, the retaining clip engages the open end of the base rail. The inner sides of the side flanges of the retaining clip therefore have a clear distance B_{SK} that is selected to be slightly greater than the distance between the outer surfaces of the legs of the base rail B_{G}. This improves handling during installation.

Preferably, a portion of the side flanges is formed as spring tabs, such that they can exert a clamping effect on the legs of the base rail when mounted. Preferably, this design as a clamping tongue is implemented on both side flanges at respective opposite sections of the side flanges. As illustrated later in the figures, the clamping tongues can be realized as sub-sections of the side flanges that are separated from the rest of the side flanges by at least one slot and are slightly bent inward. This achieves the aforementioned clamping fit during installation.

The solar modules are clamped by designing the module clamp as a component with a cross-section that is essentially T-shaped, featuring a web and two clamping jaws projecting perpendicularly from one end of the web. The clamping surface is formed by the undersides facing the web. For installation reasons, it may be advantageous for the clamping jaws to protrude from the web by different distances.

For manufacturing purposes, it has proven advantageous for the clamping jaws of the module clamp to comprise a screw-fastening area located between them, which is arranged on the upper side facing away from the web and runs parallel to the web. An opening for receiving a clamping screw is provided in the screw-fastening area. Physically, this screw-fastening area may be designed as a recess for a screw head, or as a flattened or marked area.

The support plate, as part of the module carrier, has the basic shape of a rectangle with side lengths a and b, with two opposite corners cut off along two parallel cutting edges S₁ and S₂. Here, edge a is arranged parallel to the plane of the bracket. In one embodiment variant, the distance between the two cut edges S₁ and S₂ is at most equal to the clearance width D_{G} of the base rail. If it is designed to be slightly larger, the support plate can still be inserted into the grooves while tilted sideways. The edge length a is at most equal to the distance W_{G} between the bottoms of the two grooves. This geometry ensures that a module carrier can be threaded into the base rail with the support plate leading the way, into the two grooves in the area of the gap. By rotating, the two uncut corners are seated in the groove. The bracket is oriented (with the base rail vertically oriented) such that it is at a right angle to the longitudinal extension of the base rail.

A threaded hole is provided in the end face of the bracket to accommodate a clamping screw. During installation, this is used to connect a module clamp or an end clamp to the bracket/module carrier.

The base rail, module carrier, and retaining clip can accommodate, as a base, either a module clamp with two clamping jaws or an end clamp with only one clamping jaw. Like a module clamp, the end clamp can be screwed to the bracket of the module carrier using a clamping screw.

Preferably, the components of a mounting device described above (base rail, module carrier, retaining clip, and module/end clamp) can be formed as sections of appropriately shaped extruded profiles made of aluminum or aluminum alloys. Holes and openings can be created in these profiles by milling, sawing, and punching. Alternatively, such components can also be manufactured from plastic, provided that structural design as well as building and fire safety regulations permit this. Certain components, such as the module clamp, can also be color-treated (painting, powder coating, anodizing) to achieve a color match with the solar module or its frame.

Furthermore, the clamping jaws or clamping surfaces can be fitted with elastic inserts or linings that provide cushioning within the clamp. This compensates for any residual play in the clamp and prevents the solar modules from rattling.

The installation of a mounting device, as described structurally above, can be carried out as follows: At least one long base rail (accommodating multiple mounting devices) or a plurality of sections of base rails (for individual mounting devices) is vertically fastened to an existing façade, building envelope, or substructure. Next, one (or more) module carriers are screwed into the base rail so that the support plate of the module carrier engages with the grooves in the base rail and the bracket assumes a horizontal orientation. Next, for each module carrier, a retaining clip is pushed over the front of the bracket through the through-opening until the side flanges rest against the outer sides of the legs of the base rail. The assembled combination of module carrier and retaining clip is then aligned until a predefined target position is achieved. Once this target position is reached, it is secured by fastening the retaining clip to the base rail using a retaining screw. As a final step, a module clamp is pre-mounted using a clamping screw.

When an entire array or an arrangement consisting of multiple mounting devices is attached to a façade, one or more solar modules can be installed by hooking them in and clamping them securely.

If the retaining clip has spring tabs, the mounting step of the retaining clip is simplified. The retaining screw can be installed vertically without additional tools, as the spring tension exerted by the spring tabs on the base rail ensures a sufficiently secure fit for the retaining clip and the module carrier. The fall protection required in some countries is ensured by tightening the retaining screw; in the configuration described, this screw is subjected to shear stress.

The described interaction between the base rail, module carrier, retaining clip, and modules/end clamp causes the module clamp and the module carrier to be braced against each other when the retaining screw is tightened; this presses the support plate of the module carrier into a clamping fit against the upper edge of the longitudinal groove in the base rail. If no solar module is inserted, the web/double web of the module clamp/end clamp rests on the retaining clip and presses it against the base rail. If a solar module is inserted and clamped, the clamping force from the clamping jaw of the module/end clamp acts via the frame of the solar module back onto the retaining clip, which in turn is pressed against the base rail. Thus, a mounting device can ensure a clamping fit between the module/end clamp and the base rail even without a retaining screw, whether or not a solar module is inserted between the retaining clip and the base rail.

It should be noted that the described mounting device could also be used on a roof surface where solar modules are frequently mounted at a low angle. The described mounting device then generally requires no additional fall protection, and the use of a retaining screw can be dispensed with.

Furthermore, a base rail can also be mounted horizontally on a façade if this is technically necessary or advantageous for installation. For the module carrier, the bracket arrangement need only be rotated by 90 degrees or the support plate modified accordingly. Neither of these should pose a problem for a person skilled in the art within the scope of this disclosure.

### BRIEF DESCRIPTION OF THE DRAWINGS

FIG. 1A shows a base rail 200 in cross-section; and FIG. 1B shows it in an oblique top view.

FIG. 2 shows a retaining clip in an oblique top view.

FIGS. 3A and 3B show an end clamp 600 in cross-section and in an oblique view.

FIGS. 4A and 4B show a module clamp 500 in cross-section and in an oblique view.

FIGS. 5A-5E show a module carrier 300 in various views.

FIG. 6 shows an exploded view of a mounting device according to the invention with two end clamps and a module clamp.

FIG. 7 shows an exemplary view of three mounting devices 100 in various variants.

FIG. 8 shows a variant of a base rail 200, also referred to as a hat profile.

### DETAILED DESCRIPTION

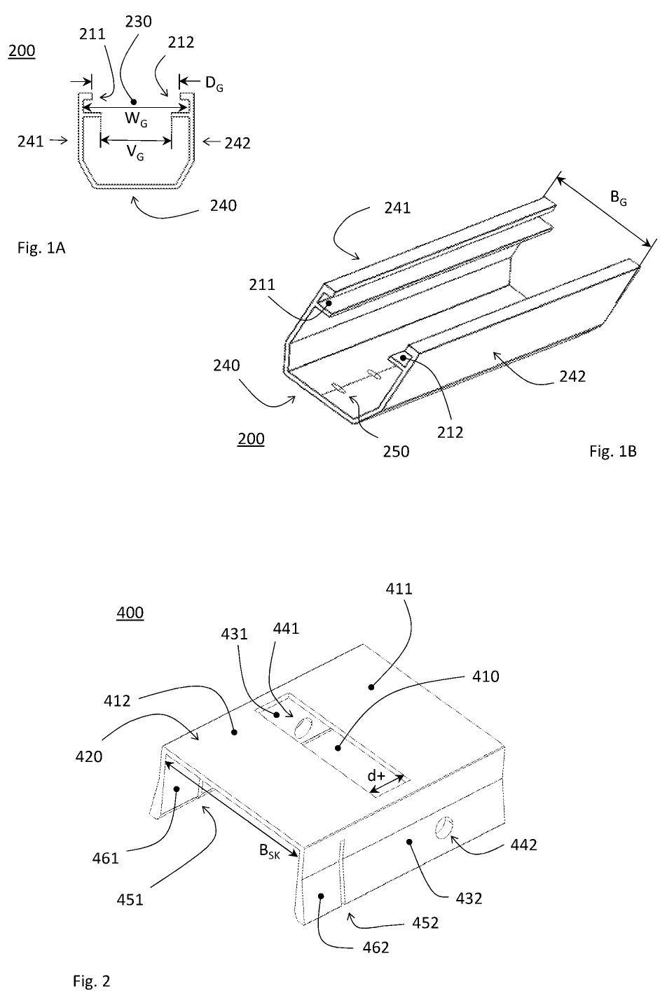

FIGS. 1A and 1B show a base rail 200 from various angles, having a preferably flat base 240 for contact with a façade and two legs 241, 242. Their alignment relative to one another is preferably parallel, at least in partial areas, in order to enable, as mentioned several times above, both a clamping fit and easier sliding on of a retaining clip 400 (see FIG. 2). At the open ends of the two legs 241 and 242 are two longitudinal grooves 211 and 212, whose openings face toward each other and thus define a gap 230 between them. The transverse dimension B_{G} of the base rail 200 is measured at the upper open end. The grooves 211 and 212 are formed with legs of different lengths, with the legs facing the opening of the base rail being shorter. This results in the passage width D_{G} of the base rail being greater than the width V_{G} of the lower constriction of the gap 230. The distance W_{G} of the longitudinal grooves 211 and 212, measured from groove bottom to groove bottom, is thus greater than both V_{G} and W_{G}. Overall, as shown in FIGS. 1A and 1B, W_{G} > D_{G} > V_{G}. In vertical installation applications, either long base rails spanning the entire façade height or short sections thereof can be installed. This depends on the façade characteristics as well as structural requirements or installation practices.

A base rail can be fastened through fastening holes 250 in the base 240. Screws, self-tapping screws, rivets, bolts, or similar fasteners may be used, depending on structural requirements or substrate conditions.

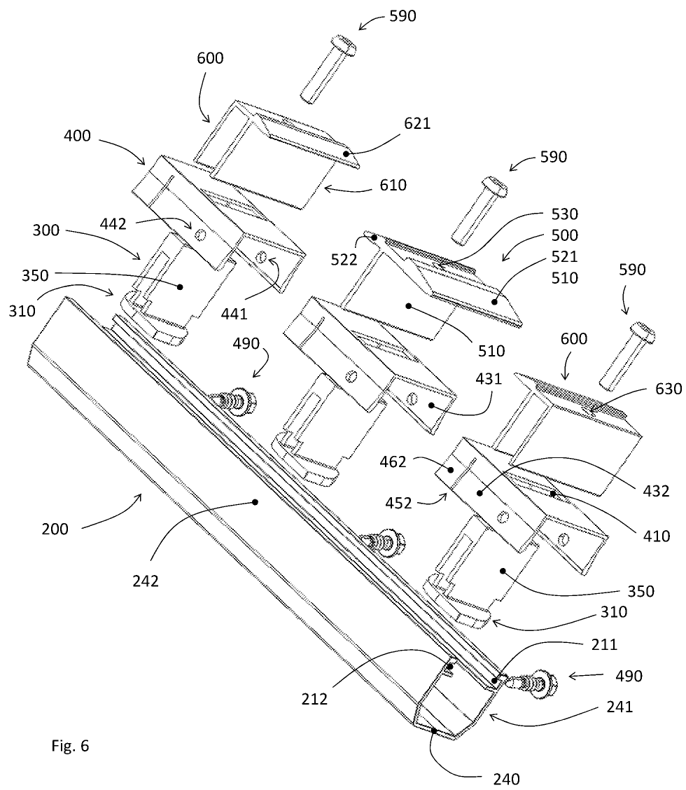

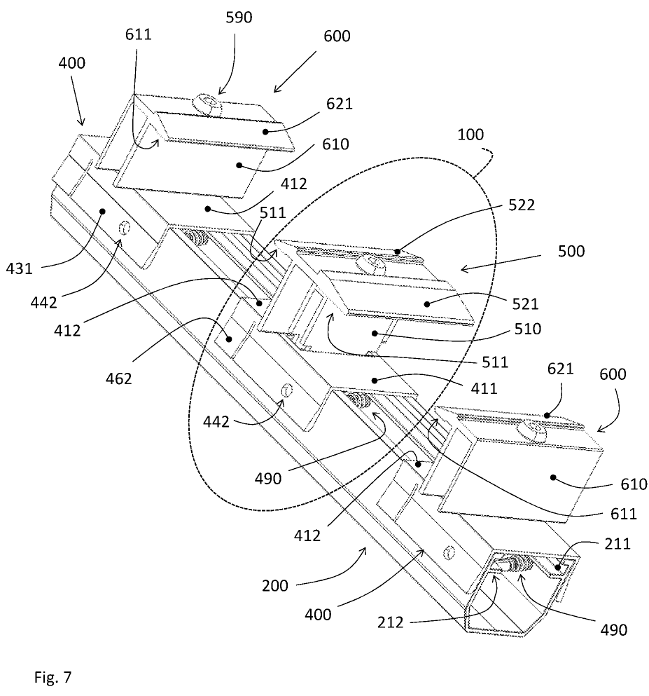

FIG. 2 shows a retaining clip 400. In cross-section, it essentially has the shape of an inverted trough with a largely flat, level clip base 420 and two longitudinally arranged, projecting side flanges 431 and 432. The surface of the clip base 420 features two clamping surfaces 411, 412, which are separated by a through-opening 410. In the example shown, the through-opening 410 is preferably rectangular, with the longer side of the rectangle oriented transverse to the side flanges 431, 432. The clear distance between the side flanges 431, 432 is B_{SK} and is selected to be slightly larger than the transverse dimension B_{G} of the base rail 200 (see FIG. 1B). Two opposing spring tabs 461, 462 are arranged on the side flanges 431, 432 of this preferred embodiment; these can be produced technically as areas of the side flanges 431, 432 that are (partially) separated by slots 451 and 452. If these areas are slightly pre-bent inward during manufacturing, they provide or increase the possible clamping force when the retaining clip is slid onto a base rail, as described previously or below with reference to FIGS. 6 and 7.

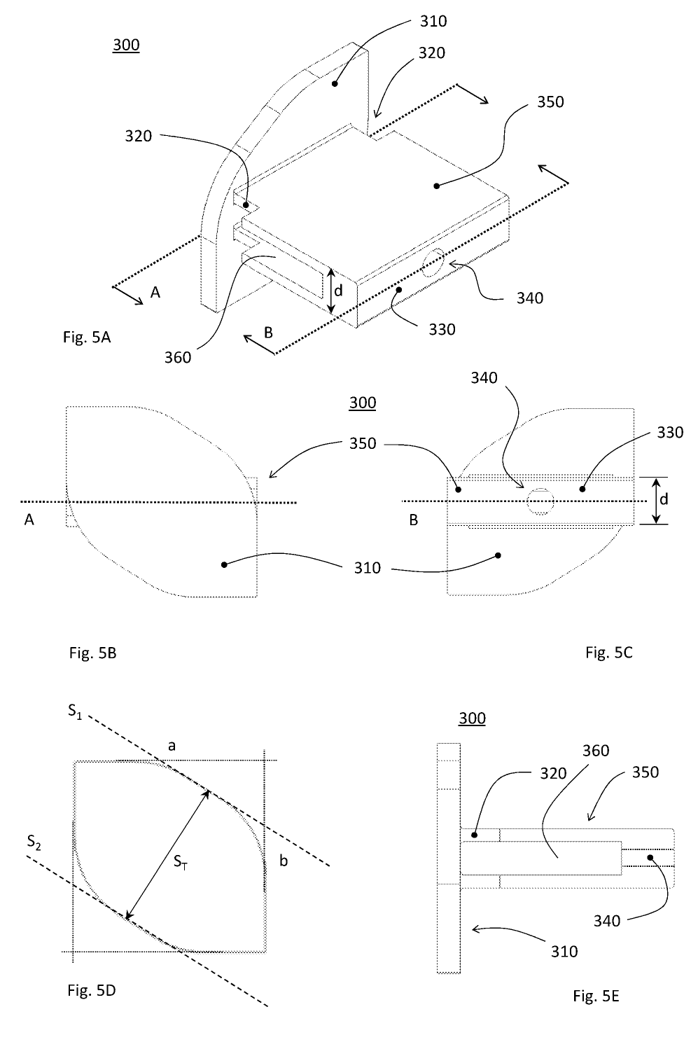

The width of the through-opening 410 is marked with d+. It is selected to be slightly greater than the thickness d of the bracket (350, see FIG. 5), thereby fulfilling the condition that the retaining clip 400 can be slid over the bracket 350 of the module carrier 300 via the through-opening 410.

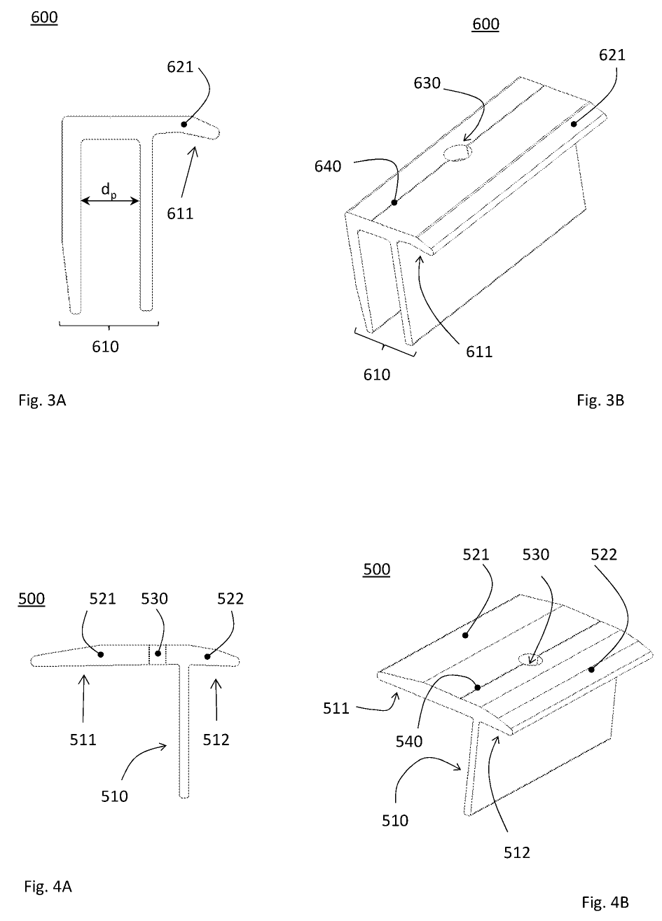

FIGS. 3A and 3B show an embodiment of an end clamp 600. It is used when only one solar module is to be clamped on one side. An end clamp 600 consists of a double web 610, wherein the clear distance between the webs is dimensioned such that a bracket fits between the webs. This distance dₚis comparable to d+ of the through-opening 410 of the retaining clip 400 and is thus also chosen to be slightly larger than the thickness d of the bracket (350, see FIG. 5). A single clamping jaw 621 protrudes from the connecting piece at the head of the double web 610 and consequently provides a clamping surface 611. As shown in FIG. 3B, the surface features a screw-fastening area 640 in which an opening 630 for a clamping screw 590 (not shown here) is provided.

FIGS. 4A and B show, in a side view and an oblique top view, respectively, a module clamp 500 as it is most commonly used for fastening a plurality of solar modules into an array. It clamps two solar modules at a time using two clamping jaws 521, 522. The module clamp 500 has only one web 510, which is attached to one side of a bracket during installation. In this design, the two clamping jaws are of different lengths, which is advantageous for a specific installation method. However, they can also be designed - for alternative installation types - such that the extension of the clamping jaws is symmetrical to the opening 530. In the illustrated embodiment, according to the mounting steps described below, the short clamping jaw 522 would point upward when mounted vertically. Thus, a solar module frame does not rest directly on the bracket 350, but on the web 510, which in turn lies flat against the bracket 350. However, this arrangement of the web is not mandatory and could be chosen differently depending on the application or requirements. A module clamp 500 could also be designed with a double web, such as the end clamp 600 with double web 610 shown in FIG. 3.

FIG. 5 consists of an oblique view (5A) over a module carrier 300, a bottom view (underside of the support plate 310) (5B), a top view of the support plate 310 from the side of the bracket 350 (5C), an auxiliary sketch describing the shape of the support plate 310, and a side view of a module carrier 300.

A module carrier 300 essentially comprises two main components: a support plate 310 and a bracket 350 arranged perpendicular to it. The support plate forms the mechanical interface to a base rail 200 (see FIGS. 1, 6, and 7) and has a shape characteristic of this function. The bracket 350 serves as a mounting point for a module clamp 500 or end clamp 600 and transfers the dead weight of a solar module via the support plate 310 into the base rail 200. The bracket 350 is designed as an essentially cuboid element with a narrow end face 330 of height d. This height d is selected, among other things, so that a threaded hole 340 can be drilled, which later serves to accommodate a clamping screw 590. At the junction between the bracket 350 and the support plate 310, two recesses 320 are provided on the narrow side of the bracket. When the module carrier 300 is positioned in the base rail 200, these recesses accommodate the upper flange of the groove(s) 211 and 212. FIG. 5A shows that the body of the bracket 350 features a recess 360. This serves to reduce weight and material. The reference lines A and B illustrate the viewing direction and viewing plane of FIGS. 5B and 5C, respectively.

FIGS. 5B and 5C show a view from below and from above of a module carrier 300. Clearly visible is the special shape of the support plate 310, the dimensions of which are further explained in connection with FIGS. 5D and E.

The support plate 310 in FIG. 5D has the basic shape of a rectangle with side lengths a and b, with two opposite corners cut off along two parallel cutting edges S₁and S₂. Here, edge a is positioned parallel to the plane of the bracket (see FIG. 5B). Then the distance S_{T} between the two cutting edges S₁ and S₂ corresponds at most to the clearance width D_{G} of the base rail, and the edge length a corresponds at most to the distance W_{G} between the bottoms of the two grooves. At the same time, it is preferable to ensure that the distance ST is greater than the width VG of the lower constriction on the base rail 200. This geometry ensures that a module carrier 300 can be inserted into the base rail 200 with the support plate 310 leading the way in the area of the gap 230 and can be threaded into the two grooves there by rotating it. The rotation causes the two uncut corners to engage in the groove. The bracket 350 is oriented such that it is aligned at a right angle to the longitudinal extension of the (vertically mounted) base rail. By arranging the bracket 350 symmetrically on the support plate 310, it is ensured that screwing the module carrier 300 into a base rail 200 does not depend on a specific orientation of the module carrier.

FIG. 5E shows a side view of the module carrier 300. The recess 360 is designed as a continuous cutout through the bracket; the threaded hole 340 is located on the front of the bracket 350 facing away from the support plate and provides sufficient thread length.

FIG. 6 shows an exploded view of a mounting device according to the invention, wherein a base rail 200 with three mounting devices is depicted, comprising two end clamps 600, one on each outer side, and a central module clamp 500. For reasons of space, not all reference signs are shown on all components. The distances between the three mounting devices would be significantly greater in reality.

The base rail 200 has a base 240 on its underside, which is connected - typically by screwing - to an existing façade. FIG. 6 shows three module carriers 300 for installation into the base rail 200 via grooves 211, 212. Installation is achieved by screwing them in, as described in FIG. 5. Three retaining clips 400 are shown in the correct position so that the through-opening(s) 410 align with the brackets 350 of the module carriers 300. In the final position, the side flanges 431, 432 will then rest against the outer sides of the legs 241 and 242. The spring tabs 462 are shown as part of the side flanges 432, formed or separated by narrow slots 452.

The openings 441 and 442 are provided as passages for a retaining screw used to secure the retaining clip 400 to the base rail 200. Depending on the installation position and the preference of the fitter, either of the two openings may be used. The module clamp 500, with its web 510 and the clamping jaws 521, 522 arranged transversely in a T-shape, and the end clamps 600, with their double web 610 and single clamping jaw 621, are shown in the correct orientation but not in their final position. During assembly, clamping screws 590 are guided through openings 530 or 630 in the module clamp 500 or end clamp 600, respectively, and engage with a corresponding thread in the bracket 350.

The design of the module clamp 500 and end clamps 600 differs from the design shown in FIGS. 3 and 4; functionally, however, the designs are the same.

FIG. 7 shows the arrangement from FIG. 6 in the assembled state, but without a solar module. The outline of an assembled mounting device 100 is indicated by the dashed border. In the following, only the essential differences from FIG. 6 and important functions will be discussed by way of example.

In FIG. 7, the module carriers (300, see FIG. 6) are inserted into or anchored in the grooves 211 and 212 of the base rail 200 and secured in their intended position by retaining clips 400, which are screwed to the base rail 200 via retaining screws 490. They are thus no longer movable along the longitudinal axis of the base rail 200.

As can be seen from the illustration of the central mounting device, the spring tab 462, which is formed as the edge section of a side flange 432, can serve as a temporary clamp during the installation of the retaining clip 400 if this section is bent inward only slightly, for example during manufacturing. As practice has shown, this spring tab 462 creates a sufficiently secure clamping fit to hold a screwed-in module carrier (300, hidden here) even when the base rail 200 is arranged vertically. Preferably, two spring tabs 461 and 462, arranged symmetrically to one another, are provided per retaining clip 400; however, this is not essential. At the same time, the module carrier can be manually moved - i.e., aligned - within the grooves 211, 212 along with the retaining clip 400 along the base rail against the resistance of the clamping fit. Since the retaining clip 400 also prevents the module carrier (300, hidden) from rotating backward, it cannot tip out of the base rail 200. An advantage is that neither a module clamp 500 nor an end clamp 600 needs to be installed at this point - which facilitates alignment. It is also irrelevant whether the selected mounting point is intended for a module clamp 500 or an end clamp 600, because the base rail 200, module carrier 300, and retaining clip 400 are identical for each of the mounting points. The module carrier can - without compromising safety - be installed in only two technically equivalent orientations; the same applies to the retaining clip 400. Installing the wrong component is not possible up to this point.

The illustration in FIG. 7 shows that the double web 610 of the end clamp 600 grips the bracket (350, not visible here) on both sides, while the web 510 does so on only one side. The arrangement of the clamping jaws 521 and 522 on both sides of the web 510 in the module clamp 500 allows for this simplification, whereas the single-sided clamping jaw 621 on the end clamp 600 requires the double web 610 for stability reasons.

A clamping screw 590 holds the module clamp 500 or end clamp 610 in place, as shown. If self-tapping screws are used as retaining screws 490, the position can be achieved through the opening 441 or 442 without pre-drilling the base rail after clamping during pre-assembly and alignment of the module carrier 300. Tests have shown that one retaining screw 490 per mounting device 100 or per retaining clip 400 is sufficient - depending on the specifications.

For the following explanation of the installation procedure, it should be noted that the "upper mounting groove" mentioned below is formed (here) by the clamping surface 511 of the module clamp 500 and the clamping surface 411 of the retaining clip 400. The corresponding "lower mounting groove" is formed (here) by the clamping jaw 621 (or its clamping surface 611) and the clamping surface 412 of the longitudinally adjacent retaining clip 400.

The width of the clamping jaws 521, 522 on a module clamp 500 is visibly different here. A wider jaw for holding the (vertically) upper edge of the solar module is known to be used to make the installation more secure. The clear vertical distance between two consecutive brackets is selected to be greater than the height of the solar module; however, the clear distance between the leading edges of two clamping jaws facing each other is less than the height of the solar module. If the module clamps 500 and end clamps 600 are pre-assembled - that is, secured using the clamping screws but not yet tightened into their final position - a particularly simple installation method can be achieved. A solar module can then be slid into the upper mounting slot mentioned above from below. Once the solar module has been slid up far enough so that its lower edge or frame can pass the clamping jaw of the corresponding lower mounting device, the solar module can be slid into the lower receiving groove mentioned above. Since the "upper" clamping jaw 521 is longer than the "lower" clamping jaw 621, the solar module remains in place and is then finally clamped by tightening the corresponding clamping screws 590. Of course, the width of the clamping jaws 521, 522 of a module clamp 500 could also be chosen to be the same, which would then allow for a particularly tight installation of solar modules, albeit with increased effort required to temporarily secure a solar module during installation.

Another advantage of the proposed solution is that adaptation to various frame widths or depths of solar modules is possible within wide limits by adjusting only the height of the web 510/double web 610 or the bracket 350. The basic design principles remain unchanged in each case, as does the installation procedure, including the tools used.

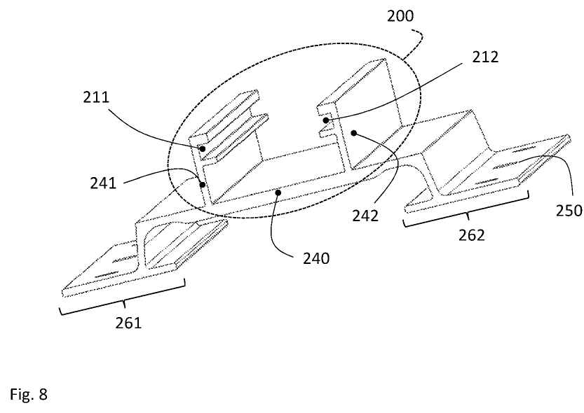

FIG. 8 shows a variant of a base rail 200, depicted here as "having a U-shaped section." Several key structural and functional features are shown, such as the base 240, the legs 241 and 242, and the longitudinal grooves 211 and 212. This also makes it clear that interaction with a module carrier, a retaining clip, and a module/end clamp is ensured, just as for the base rail shown in FIGS. 1A and 1B. The profile shown in FIG. 8 is a hat-shaped profile, with the base rail 200 serving as the cap and two extensions 261 and 262 serving as the brim. These extensions 261 and 262 feature fastening holes 250 that serve to secure the profile to a substrate. While the profile shown in FIG. 1 is particularly suited for use on trapezoidal sheets, the hat-shaped profile shown in FIG. 8 can be attached in particular to existing, flat façade panels.

The embodiments shown in the figures are exemplary and therefore do not preclude alternative or technically equivalent embodiments. Individual features of components may belong to preferred embodiments. In case of doubt, the wording and allocation in the filed claims are decisive.

1. A mounting device (100) for fall-proof fastening of solar modules, the mounting device (100) comprising:
a longitudinally extended base rail (200) for attachment to an existing façade, the base rail (200) comprising a base (240) with two legs (241, 242) projecting therefrom, and two longitudinally extending grooves (211, 212) are arranged at an open end of the legs (241, 242), with openings (221, 222) of said two longitudinally extending grooves (211, 212) facing each other and defining a gap (230) therebetween;
a module carrier (300) having a support plate (310) and a bracket (350) projecting perpendicularly therefrom, said bracket (350) having an end face (330) running parallel to the support plate, wherein the support plate (310) is adapted to be engaged with the longitudinal grooves (211, 212) of the base rail (200) and for positioning in the gap (230);
a retaining clip (400) having a through-opening (410) which, when mounted, surrounds the bracket (350) in a collar-type manner and simultaneously grips the base rail (200), and which is adapted to be connected to the base rail (200) by a retaining screw (490); and
a module clamp (500) or an end clamp (600), which is adapted to be screwed to the bracket (350) of the module carrier (300) by a clamping screw (590) with the end clamp being adapted to retain one solar module or the module clamp being adapted to retain two solar modules.

2. The mounting device (100) according to claim 1, wherein the module clamp (500) has two separate clamping surfaces (511, 512), which each, along with corresponding clamping surfaces (411, 412) of the retaining clip (400), form a pair of clamping jaws (411, 511) (412, 512).

3. The mounting device (100) according to claim 1, wherein the end clamp (600) has a single clamping surface (611) that, along with with one clamping surface (411,412) of the retaining clip (400), forms a pair of clamping jaws (611) (412 or 512).

4. The mounting device according to claim 1, wherein outer surfaces of the legs (241, 242) of the base rail (200) are aligned parallel to one another at least in sections.

5. The mounting device (100) according to claim 2, wherein the retaining clip (400) has a U-shaped cross-sectional structure with a clip base (420) and two side flanges (431, 432) projecting therefrom, and outer side of the clip base (420) comprise the clamping surfaces (411, 412).

6. The mounting device (100) according to claim 5, wherein the through-opening (410) of the retaining clip (400) is dimensioned to be slipped over the module carrier (300) for installation, such that the bracket (350) is adapted be guided through the through-opening (410) with the end face (330) thereof leading and with minimal clearance.

7. The mounting device according to claim 5, wherein the clamping surfaces (411, 412) are separated from one another by the through-opening (410).

8. The mounting device (100) according to claim 5, wherein inner sides of the two side flanges (431, 432) of the retaining clip (400) have a clear distance B_{SK} that is selected to be greater than the distance B_{G} between outer surfaces of the legs (241, 242) of the base rail (200).

9. The mounting device (100) according to claim 5, wherein a portion of the side flanges (431, 432) are formed as spring tabs (461, 462) which, when mounted, exert a clamping effect on the legs (241, 242) of the base rail (200).

10. The mounting device (100) according to claim 1, wherein the module clamp (500) has a substantially T-shaped cross-section consisting of a web (510) and two clamping jaws (521, 522) projecting perpendicularly from one end of the web (510), with the clamping jaws (521, 522) projecting at right angles from the one end of the web (510), each of the clamping jaws (521, 522) has a clamping surface (511, 512) on an underside thereof facing the web (510).

11. The mounting device (100) according to claim 10, wherein the clamping jaws (521, 522) project from the web (510) by different distances.

12. The mounting device (100) according to claim 10, wherein a screw-fastening area (540) is arranged between the clamping jaws (521, 522), which extends parallel to the web on an upper side facing away from the web (510).

13. The mounting device (100) according to claim 12, wherein an opening for receiving a clamping screw (590) is provided in the screw-fastening area (540).

14. The mounting device (100) according to claim 1, wherein the support plate (310) has a basic rectangular shape with side lengths a and b, with two opposite corners cut off along two parallel cutting edges S₁ and S₂wherein one of the edges lies parallel to a plane of the bracket (350), and the side length a of said one of the edges corresponds at most to a distance W_{G} between bottoms of the two grooves (211, 212).

15. The mounting device (100) according to claim 1, wherein a threaded bore (340) is arranged in the end face (330) of the bracket (350).

16. A method for vertical installation of the mounting device (100) according to claim 1, comprising the following steps of:
vertically fastening at least one said base rail (200) or a plurality of sections of the base rails (200) to an existing façade or building envelope;
screwing the module carrier (300) into the base rail (200) such that the support plate (310) engages with the grooves (211, 212) of the base rail (200) and the bracket (350) assumes a horizontal orientation;
sliding the retaining clip (400) over the end face (330) of the bracket (350) through the through-opening (410) until the side flanges (431, 432) abut outer sides of the legs (241, 242) of the base rail (200);
aligning the module carrier (300) and the retaining clip (400) until a predefined target position is achieved;
securing the predefined target position of the module carrier (300) and the retaining clip (400) by fastening the retaining clip to the base rail (200) using a retaining screw (490); and
attaching the module clamp (500) using the clamping screw (590).

17. The method according to claim 16, wherein the retaining clip (400) comprises spring tabs (461, 462) which hold the retaining clip (400) in a clamping fit after the retaining clip (400) has been slid onto the base rail (200).

18. The method according to claim 16, wherein an arrangement for receiving and clamping one or more solar modules is formed by attaching a plurality of the mounting devices (100).
